(19) United States
(12) Patent Application Publication
(10) Pub. No.: US 2010/0326740 A1
(43) Pub. Date: Dec. 30, 2010

(54) Bonded Assembly Having Low Residual Stress

(76) Inventors: David R. Hall, Provo, UT (US); H. Tracy Hall, JR., Provo, UT (US)

Correspondence Address: TYSON J. WILDE;NOVATEK INTERNATIONAL, INC., 2185 SOUTH LARSEN PARKWAY, PROVO, UT, 84606, US

(21) Appl. No.: 12/492,804

(22) Filed: Jun. 26, 2009

(51) Int. Cl. E21B 10/573; B23K 20/00; B29C 65/02; B29C 65/16; B29C 65/06; B23K 20/12; B23K 13/01

(52) U.S. Cl. 175/428; 228/196; 156/309.9; 228/176; 156/273.3; 156/272.8; 156/73.5; 228/112.1; 219/603

(57) ABSTRACT

In one aspect of the present invention, a method for forming a bonded assembly comprises providing a first and second portion of the assembly; preparing a mating surface on each portion that conforms substantially to the mating surface of the other portion; rapidly heating a bonding material while substantially heating no more than a thin surface zone adjacent each mating surface, and rapidly assembling the two portions in such a manner as to confine a fraction of the bonding material between the mating surfaces. The first portion may comprise polycrystalline diamond or thermally stable polycrystalline diamond; the second portion may comprise cobalt-cemented tungsten carbide. The assembly may comprise a tool for high-impact applications.

### BACKGROUND OF THE INVENTION

This invention relates to providing a strong thermally-actuated bond between two parts in such a manner that only a thin zone within each part near the bond is heated to any significant degree. A braze or weld material may be employed as a separate small body. The process provides a bonded assembly having low residual stress and is especially useful for bonding dissimilar materials. Such an assembly is particularly useful for tools such as are used in earth boring drill bits, asphalt degradation equipment, and any application that may be subject to high impact forces and high temperatures.

Efforts to lengthen the life of such tools by reducing internal stress are disclosed in the prior art. U.S. Pat. No. 7,487,849 to Radtke discloses a cutting element and a method for making the same. The cutting element includes a substrate, a Thermally Stable Polycrystalline (TSP) diamond layer, a metal interlayer between the substrate and the diamond layer, and a braze joint securing the diamond layer to the substrate. The thickness of the metal interlayer is determined according to a formula that takes into account the thickness and modulus of elasticity of the metal interlayer and the thickness of the TSP diamond. This prevents the use of metal interlayer that is too thin or too thick. A metal interlayer that is too thin is not capable of absorbing impact energy, and a metal interlayer that is too thick may allow the TSP diamond to fracture from bending stress. A coating that serves as a thermal barrier and controls residual thermal stress may be provided between the TSP diamond layer and the metal interlayer.

U.S. Pat. No. 6,220,375 to Butcher et al. discloses that the residual stresses in polycrystalline diamond cutters can be reduced by selectively thinning the carbide substrate subsequent to high temperature, high pressure (sintering) processing, by selectively varying the material constituents of the cutter substrate, by subjecting the PDC cutter to an annealing process during sintering, by subjecting the formed PDC cutter to a post-process stress relief anneal, or a combination of those means.

U.S. Pat. No. 5,049,164 to Horton et al. discloses a method of reducing the strain induced in a composite cutter when it is brazed or bonded into a bit. Although it does not teach means for reducing the residual stress that is inherent in the cutter itself, it illustrates the vulnerability of such cutters to thermal stresses that arise during bit manufacture.

U.S. Pat. No. 5,176,720 to Martell et al. discloses a method of reducing the inherent residual thermal stress in a composite abrasive compact that includes the steps of providing a cemented carbide substrate having two layers separated by a metallic layer. The metal of the metallic layer may be a ductile metal such as cobalt or nickel or a refractory, carbide-forming metal such as molybdenum, tantalum, niobium, hafnium, titanium or zirconium. A layer of the components, in particulate form, necessary to produce an abrasive compact is placed in a recess of the one layer to produce an unbonded assembly. The unbonded assembly is then subjected to suitable conditions of elevated temperature and pressure to produce an abrasive compact from the components. This method is said to reduce residual stresses in the compact.

### BRIEF SUMMARY OF THE INVENTION

In one aspect of the present invention, a method for forming a bonded assembly comprises providing a first and second portion of the assembly; preparing a mating surface on each portion that conforms substantially to the mating surface of the other portion; rapidly heating a bonding material while substantially heating no more than a thin surface zone adjacent each mating surface, and rapidly assembling the two portions in such a manner as to confine a fraction of the bonding material between the mating surfaces.

A typical application for such a bonded assembly is a high impact tool. Typically the first portion of the tool comprises a hard material, preferably a material such as thermally stable polycrystalline diamond, and the second portion comprises a strong support material, preferably cobalt-cemented tungsten carbide. The tool may comprise a working surface that is substantially pointed, substantially dome shaped, substantially cylindrical, or substantially flat.

The bonding material may comprise any combination of a thin surface zone including the mating surface of at least one portion, a thin coating substantially covering at least one of the mating surfaces, or a separate small body, such as a piece of weld or braze material. The bonding material may comprise any number of materials that may bond with the mating surface of either portion at high temperatures. It may be provided as a thin foil or wire provided as a separate small body, which may be rapidly heated by an electric current, as by discharge of a capacitor.

The key aspect of the invention is that only the bonding material is raised to any significant temperature, and that the bonding material has a sufficiently small mass that the heat stored in the bonding material that is trapped at the instant of assembly is insufficient to heat the bulk of either part to any significant temperature. The bonding material may be heated to above its melting temperature or even to above its boiling temperature, but shortly after assembly the parts will be near room temperature.

### BRIEF DESCRIPTION OF THE DRAWINGS

FIG. 1 is a perspective view of an embodiment of a shear bit for drilling in the earth.

FIG. 2 is a perspective view of an embodiment of a high impact tool.

FIG. 3a is a cross-sectional view of an embodiment of a process for making a high impact tool.

FIG. 3b is a cross-sectional view illustrating a later stage in the process illustrated by FIG. 3a.

FIG. 4 is a cross-sectional view of another embodiment of a high impact tool.

FIG. 5a is a cross-sectional view of an embodiment of a process for making a high impact tool such as is illustrated in FIG. 4.

FIG. 5b is a cross-sectional view of an intermediate stage in the process illustrated in FIG. 5a.

FIG. 5c is a cross-sectional view of a later stage in the process illustrated in FIG. 5b.

FIG. 6 is an embodiment of a method for forming a high impact tool.

### DETAILED DESCRIPTION OF THE INVENTION AND THE PREFERRED EMBODIMENT

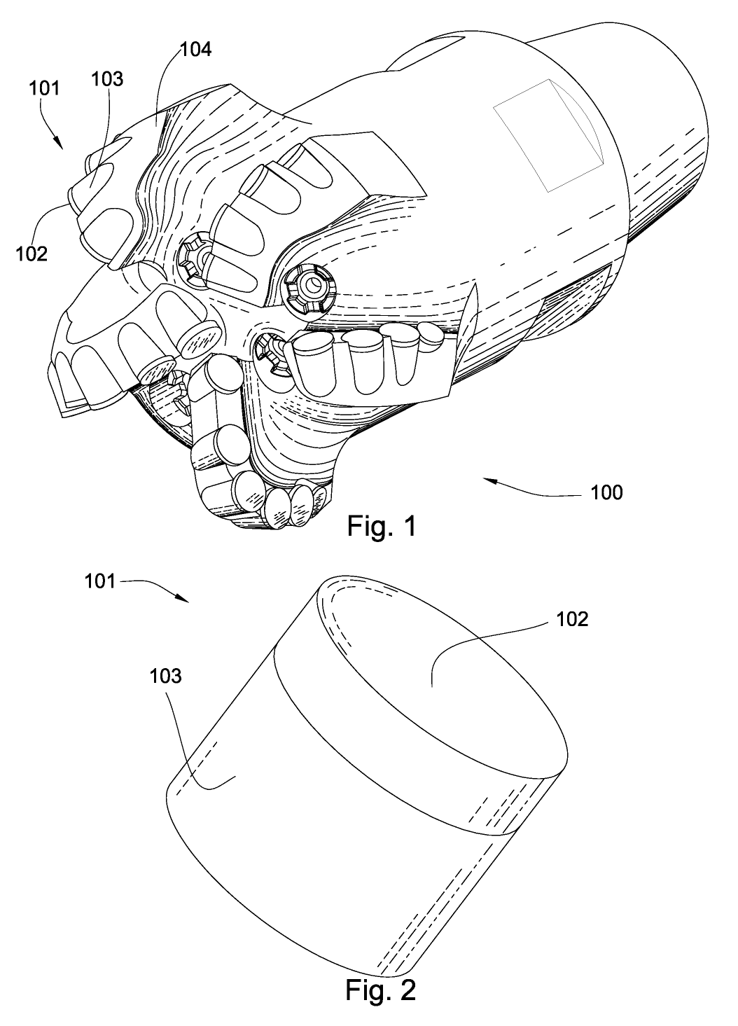

Referring now to the figures, FIG. 1 discloses a rotary shear bit 100 comprising high impact tools 101. High impact tools 101 may comprise a polycrystalline diamond, cubic boron nitride, or other super-hard material layer 102 and a cemented metal carbide substrate 103. High impact tools 101 may be pressed into pockets on the bit body 104, may be brazed to pockets in the bit body 104, or may be attached by another method, including the method of the present invention.

Many prior art high impact tools comprise a polycrystalline diamond layer and a cemented metal carbide substrate sintered together in a high pressure, high temperature press. The polycrystalline diamond bonds to the carbide substrate at a temperature sufficient to melt the binder/catalyst material and at a pressure sufficient to maintain the thermodynamic stability of the diamond. Since the carbide substrate has a higher coefficient of thermal expansion than polycrystalline diamond, the carbide will contract more than the polycrystalline diamond upon cooling, thereby inducing stress in both the polycrystalline diamond layer and in the substrate. This residual stress may have deleterious effects on the life of the high impact tools by contributing to spalling and delamination. It is desirable to bond the polycrystalline diamond layer to the carbide substrate in a manner that minimizes or substantially eliminates residual thermally induced stress. Additionally, it is desirable to dedicate the expensive press time to making the diamond layer alone and to bond the diamond to the carbide outside the press. The present invention provides not only a less expensive part, but by eliminating residual stress, it provides a more strongly bonded part.

The present invention may provide bonded assemblies for many applications, including impacting, fracturing, crushing, abrading, cutting, indenting, scraping, shearing, compressing, resisting abrasion, resisting erosion, resisting corrosion, or providing a bearing surface.

Referring now to FIG. 2, an embodiment of a high impact tool 101 is disclosed. High impact tool 101 comprises a polycrystalline diamond layer 102 and a cemented metal carbide substrate 103. Polycrystalline diamond layer 102 may be processed in a high pressure high temperature press, and the carbide substrate 103 may be sintered in a separate operation. Polycrystalline diamond layer 102 and carbide substrate 103 are then bonded together in the separate operation of the present invention. A preferred material for the cemented metal carbide substrate is cobalt-cemented tungsten carbide, but other carbides may be used such as, but not limited to, titanium carbide, niobium carbide, tantalum carbide, silicon carbide, or combinations thereof.

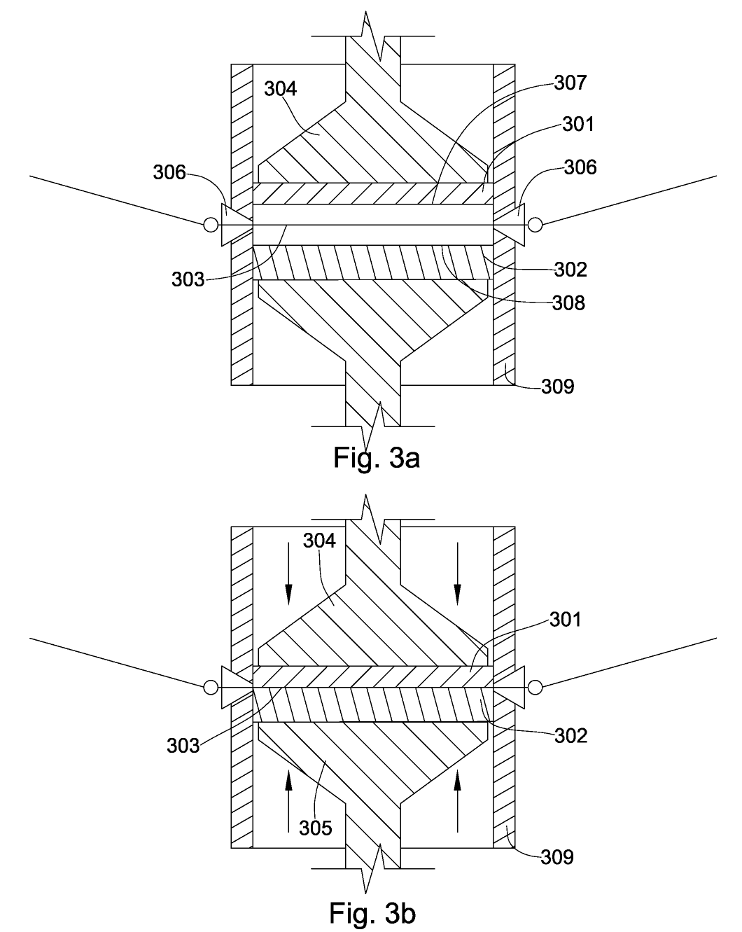

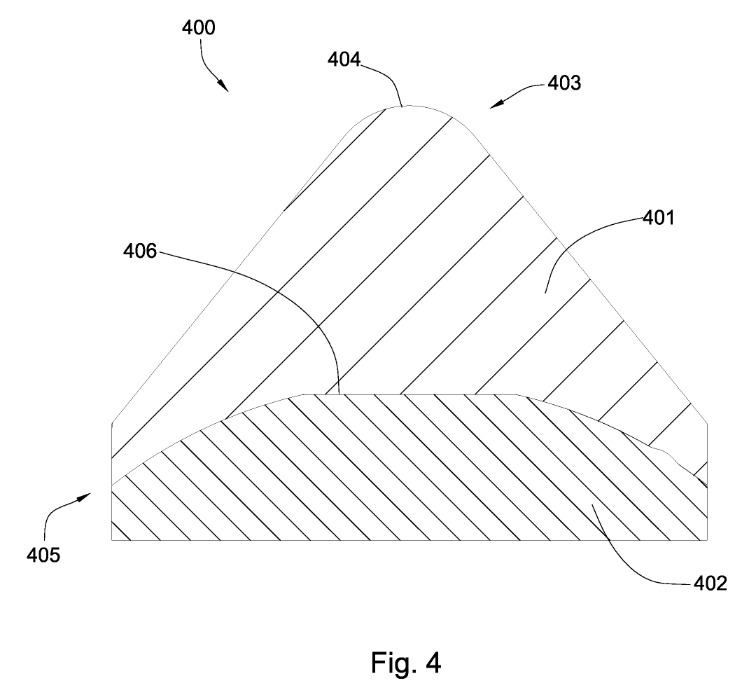

FIG. 3a discloses a polycrystalline diamond, cubic boron nitride, or other superhard material first portion 301; and a cemented metal carbide second portion 302 of a high impact tool. Bonding material 303 is disposed intermediate first and second portions 301, 302 and comprises a thin sheet of electrically conductive material that has approximately the same diameter as portions 301 and 302. Anvils 304 and 305 locate portions 301 and 302 at a predetermined distance from each other. Electrodes 306 connect to the bonding material 303 and hold the bonding material in position. The bonding material 303 may comprise tantalum, molybdenum, tungsten, cobalt, nickel, iron, titanium, zirconium, hafnium, vanadium, niobium, chromium, manganese, rhenium, ruthenium, rhodium, iridium, palladium, platinum, copper, silver, gold, zinc, cadmium, boron, aluminum, gallium, indium, silicon, germanium, tin, lead, antimony, bismuth, beryllium, magnesium, a lanthanoid, a carbide, a metal hydride, carbon or graphite, an intercalated graphite compound, a metal-coated polymer, an electrically conducting polymer, a metal-coated ceramic, an electrically conducting ceramic, a cermet, or a semiconductor. Alloys and multiple layers of any combination of these materials also fall within the scope of the invention.

The first portion 301 and second portion 302 comprise mating surfaces 307 and 308. The mating surfaces may be lapped or ground to a desired surface finish depending in part on the chosen thickness of the bonding material 303. In this embodiment, the mating surfaces are planer.

In FIG. 3b, the bonding material 303 is rapidly heated to a predetermined temperature and the anvils 304, 305 are closed rapidly and forcefully, pressing the heated bonding material 303 between the first and second portions 301, 302. Anvils 304, 305 may be actuated by hydraulic, mechanical, pneumatic, or other means capable of generating sufficient speed and force to trap the bonding material between the mating surfaces and to eliminate any voids therein. In some embodiments, the forceful advance of the anvils is automatically programmed into the heating equipment and may be controlled by feedback from one or more temperature sensors.

The bonding material should be heated as rapidly as possible, so as to prevent heating of any substantial zone beneath the mating surfaces of portions 301 and 302. One purpose of the present invention is to eliminate or minimize residual stress in the final product, which occurs due to a mismatch of thermal expansions in the first and second portions. It is believed that a shorter heating time will result in less transfer of heat to both portions, resulting in less thermal expansion thereof prior to bonding. It is further believed that to form a strong bond, it is only necessary to heat the surfaces of both portions before they are brought together. Thus, preferably the bonding material is instantaneously heated as the anvils forcibly bring the first and second portions together.

It is further believed that a thinner bonding material (thus, a smaller volume of material to heat) will help facilitate rapid heating. In some embodiments, the bonding material may be less than one tenth of one millimeter (0.004 inches) thick. A mechanism capable of rapidly discharging a large amount of electrical current may help facilitate the rapid heating. Such a mechanism may include a battery, a transformer, a low-internal resistance AC or DC power supply, a capacitor, a homopolar generator, or a Marx generator.

In some embodiments, the bonding material 303 comprises tungsten, which may react with a tungsten carbide second portion 302 to form tungsten carbide and react with the polycrystalline diamond first portion 301 to also forming tungsten carbide. In applications where a different cemented metal carbide substrate is used, the bonding material may match the metal of the carbide. For example, when using a titanium carbide, a bonding material comprising titanium may be used. However, the bonding material does not necessarily need to match the metal of the cemented metal carbide.

This process of heating the bonding material and pressing the bonding material between the first and second portions may take place in a very short time, preferably substantially less than one second, most preferably less than one tenth of one second. In this way, the polycrystalline diamond first portion is bonded to the carbide substrate second portion without significantly raising the average temperature of the first portion 301 or of the second portion 302. The diamond is thereby bonded to the carbide substrate substantially without the thermally induced residual stresses that arises from the prior-art process of bonding the diamond and carbide together at high temperature in the press.

In general it is desirable to conduct the process so rapidly that the maximum temperature ever obtained within either portion falls off as steeply as possible as a function of distance from either mating surface. When first portion 301 comprises diamond and second portion 302 comprises cobalt-cemented tungsten carbide, it is most preferable that the heating and assembly cycles be optimized such that at no time during the process does the temperature at a distance exceeding about 0.5 millimeter (about 0.020 inches) normal to the mating surface of carbide portion 302 exceed about 900 Celsius (1173 Kelvin), even though the maximum temperature at the mating surface itself may momentarily exceed the melting point of cobalt (1495 C, 1768 K). The high thermal conductivity and low heat capacity of diamond may result in a higher maximum temperature profile as a function of distance normal to the mating surface within diamond portion 301 compared to the corresponding profile within carbide portion 302, but the effect of the higher temperature profile within the diamond on any residual stress in the bonded part is offset by the lower coefficient of thermal expansion of diamond.

Bonding the carbide substrate with the super-hard material outside of a high temperature high pressure press allows more super-hard material to be processed in a single press run. Thus, the press throughput may be increased substantially compared to the prior-art process of bonding the super-hard material to the substrate in the press.

The first portion 301 may comprise thermally stable polycrystalline diamond, such as a leached sintered diamond or a diamond sintered with a nonmetallic catalyst. Known processes for rendering polycrystalline diamond thermally stable include acid leaching, electrolytic dissolution; ion implanting, diffusing with another material, or alloying. Such processes may increase the ability of the diamond portion to withstand high working temperatures and stresses without failure, and such diamond portions may be used in this embodiment.

The process of heating the bonding material and pressing the first and second portions together may be carried out within a sleeve 309. Sleeve 309 may comprise a refractory material such as an oxide of aluminum, magnesium, or silicon; hexagonal boron nitride, or any other materials that is electrically insulating and can withstand a brief surface exposure to high temperature.

The heating and pressing processes are preferably performed in a vacuum chamber to prevent contamination of the bonding material 30, to minimize conductive or convective heating of the mating surfaces of portions 301 and 302, and to avoid voids in the bond that may arise from entrapment of a gas withing molten bonding material. However, with suitable precautions to avoid overheating the mating surfaces or entrapment of gas in the bond, the bonding may also be conducted in a reducing atmosphere, such as in forming gas, or in an inert atmosphere, such as argon, helium, or nitrogen.

Referring again to FIG. 3b, another preferred embodiment would be to employ element 303 as a heater only. The bonding material may comprise a thin surface zone of the material comprising portions 301 and 302, respectively. Alternatively, at least one of the mating surfaces of portions 301 and 302 may be coated with a bonding material different from the material comprising the bulk of either portion. For example, if portion 301 comprises polycrystalline diamond, its mating surface 307 may be first coated with a thin layer of titanium, followed with a thin layer of cobalt. If portion 302 comprises cobalt-cemented tungsten carbide, its mating surface 308 may be coated with a thin layer of cobalt. Coated elements 301 and 302 may be treated in a separate process to enhance adhesion of the coating to the element, such as by heating, by ion bombardment, or by shot-peening. In this embodiment element 303 may comprise a thin wire, rod, or foil of a refractory metal such as tungsten or molybdenum. The wire or foil is flash heated by an electrical discharge and the coated mating surfaces are rapidly heated by radiation within the black body bounded by the mating surfaces 307, 308 and the inside surface of sleeve 309. As soon as the surface of the cobalt coating on each surface 307, 308 begins to melt, heater wire or foil 303 is rapidly withdrawn from between the mating surfaces, and the mating surfaces are trapidly brought together.

FIG. 4 discloses a high impact tool 400 comprising pointed geometry 403. High impact tool 400 may be used in implements such as shear bits, percussion bits, or roller cone bits; equipment for disintegration, fracturing, or degradation of stone, concrete, or asphalt, or other machinery employing high impact on any kind of material. Pointed geometry 403 comprises an apex 404 with a radius typically between about 0.05 inches (about 1.3 millimeter) and about 0.1 inches (about 2.5 millimeter).

High impact tool 400 comprises a first portion 401 comprising polycrystalline diamond and a second portion 402 comprising carbide. The second portion 402 may be pressed into a bit body or tool, be brazed to a tool, be bonded to a tool by the process of the present invention, or be retained in some other way. Tool 400 comprises a non-planer interface 405 with a raised central portion 406.

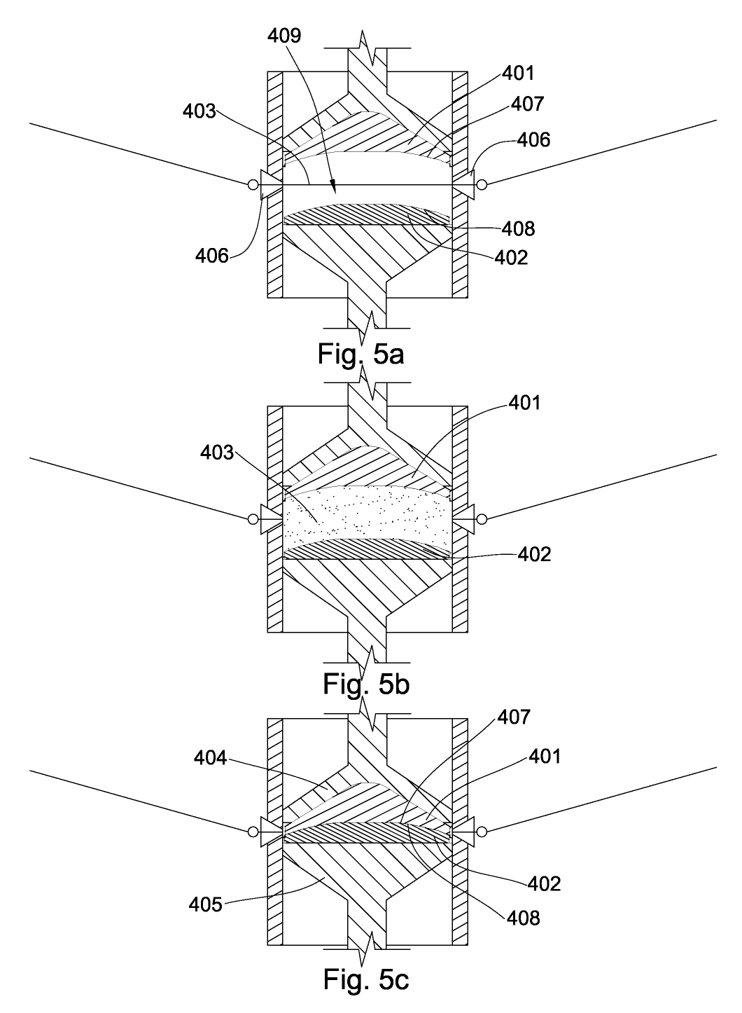

In another embodiment disclosed in FIG. 5a, mating surfaces 407 and 408 of a polycrystalline diamond first portion 401 and a carbide second portion 402 comprise a metallic coating. The metallic coating may comprise tantalum, molybdenum, tungsten, cobalt, nickel, iron, titanium, zirconium, hafnium, vanadium, niobium, chromium, manganese, rhenium, ruthenium, rhodium, iridium, palladium, platinum, copper, silver, gold, zinc, cadmium, boron, aluminum, gallium, indium, silicon, germanium, tin, lead, antimony, bismuth, beryllium, magnesium, a lanthanoid, or other metals or alloys thereof. The coating may be applied by chemical vapor deposition, by sputtering, by dipping in molten metal, or by other methods.

In one preferred embodiment, thermally stable polycrystalline diamond portion 401 is first coated with a metal such as titanium, zirconium, hafnium, vanadium, niobium, tantalum, chromium, molybdenum, tungsten, manganese, rhenium, ruthenium, rhodium, iridium, palladium, platinum, boron, silicon, or a lanthanoid; and the first coating is subsequently coated with any combination of the group comprising cobalt, nickel, iron, copper, silver, gold, zinc, cadmium, beryllium, magnesium, aluminum, gallium, indium, germanium, tin, lead, antimony, or bismuth. A coating of titanium followed by cobalt is most preferred for the diamond portion 401, and a coating of cobalt is most preferred for the carbide portion 402. Each coated part 401 and 402 is then subjected to a separate step to optimize adhesion of the coating to the diamond or the carbide, respectively.

In this embodiment, the mating surfaces may comprise a non-planer interface 409. It is believed that the non-planer interface 409 may increase the strength of the bond by increasing the bond surface area and by providing more direct resistance to vector forces that are directed off-normal.

The bonding material 403 may comprise any electrically conducting material. The bonding material may be formed as a wire, a foil portion, or another suitable form. Most preferably it is a thin foil of tungsten or tantalum having the same diameter as portions 401 and 402. The bonding material may be retained by conductive electrodes 406. The conductive electrodes may be in electrical communication with a source of high current, such as a capacitor capable of delivering sufficient current to heat the bonding material 403 to a predetermined temperature in a short time. As is well known in the art, rapid and efficient transfer of energy from the power source to the bonding material can be best obtained by matching the electrical impedance of source to that of the sink.

In FIG. 5b, a capacitor has discharged a large amount of current through the bonding material in a short time thus completely vaporizing the bonding material 403. The necessary temperature to vaporize the bonding material depends on the composition of the bonding material. In one embodiment, the bonding material comprises cobalt, which has a boiling point of about 3143 K and a heat of vaporization of about 376 KJ (thousand Joules) per mole.

In an alternative embodiment, the bonding material is only melted. It may comprise a eutectic mixture, for example 45 weight percent tungsten and 55 weight percent cobalt, and the bonding material may be heated to a eutectic temperature associated with that composition. Alternatively, if the foil is sufficiently thin to facilitate rapid diffusion, a eutectic composition can be obtained by providing a thin coating of cobalt on each side of a tungsten foil. The eutectic temperature represents the lowest melting point possible for a mixture of given constituents, and allows the bonding material to be melted while minimizing heat transfer to the first and second portions 401 and 402. In a related embodiment, the bonding material and heater 403 may comprise a thin ground sheet of cobalt-cemented tungsten carbide. Such a heater will partially melt at the ternary Co—W—C eutectic of 1270 C. Depending on the relative proportions of cobalt and tungsten carbide, heating to a temperature exceeding 1270 C will melt an increasing fraction of the heater, until it is fully melted.

Now referring to FIG. 5c, the first portion 401 and the second portion 402 are pressed together between anvils 404 and 405. The vaporized bonding material is compressed and condenses on the mating surfaces 407 and 408 as the anvils 404 and 405 close. Heat from the condensing bonding material may substantially melt the surface of the metallic coating on the first and second portions, and the bonding material may partially or substantially diffuse into the metallic coating.

In some embodiments, the bonding material and metallic coating may form a eutectic mixture at the interface between the mating surfaces. As a eutectic mixture cools, the components of the mixture solidify simultaneously and may lead to desirable microstructural properties. Depending on the constituent materials chosen for the bonding material and the metal coating on the mating surfaces, mixtures in the hypoeutectic regions and hypereutectic regions may also provide desirable microstructural properties resulting in a high strength bond between the polycrystalline diamond first portion and the carbide second portion. Materials that form solid solutions in each other also form desired bonding materials for the present invention.

Another means of evaluating bond materials is by the contact angle that the molten material forms with a solid surface of the other material. If the contact angle is zero, the molten material will spread of its own volition across the solid surface. For example, molten cobalt is thought to have a zero contact angle with tungsten carbide. On the other hand, molten cobalt has a contact angle less than zero with diamond. For this reason it is desirable to provide a carbide-forming intermediate layer such as titanium between diamond and cobalt. In any event, the contact angle formed between any two bonding materials selected for the present invention should be less than 90 degrees.

In some embodiments it may be desirable for a substantial fraction of any melted or vaporized bonding material to be rapidly expelled from the bond zone. In cases where a lower-melting or weaker bonding material, such as a braze or solder alloy is used, this may enhance the strength of the bond. In all cases it is desirable to have a minimum mass of hot bond material so as to minimize the depth of the zone that is heated on either side of the bond. It is desirable that the heat capacity of the fraction of the bonding material that is trapped between the two portions, at the bonding temperature, be less than one-half of the heat capacity of either portion at room temperature, most preferably less than one-tenth of the heat capacity of either portion at room temperature.

In yet another alternative embodiment, the bonding material 403 is neither substantially melted nor vaporized, but instead comprises a refractory electrically conductive material having a very high melting point that serves as a heater and is subsequently captured and retained as a bond material. The mating surfaces of portions 401 and 402 are coated with a thin coating of a material that melts at a lower temperature the heater. In one preferred embodiment, portion 401 comprises diamond and is first coated with titanium and then cobalt on mating surface 407, portion 402 is cobalt-cemented tungsten carbide and is coated with cobalt on surface 408. Coated parts 401 and 402 are then annealed to enhance adhesion of the coating. Bonding material and heater 403 comprises tantalum, which has a melt temperature of about 3290 K. (Cobalt melts at 1768 K.) Tantalum heater 403 is flash-heated to near its melting point, and parts 401 and 402 are then rapidly brought together. The tantalum is sufficiently hot to provide instantaneous surface melting of the cobalt coating on parts 401 and 402, thereby providing an instant weld sandwich comprising diamond portion 401; thin layers of titanium, cobalt, tantalum, and cobalt; and carbide portion 402. Tantalum may is preferred as a captured heater because of its excellent strength and ductility, but tungsten or another strong refractory metal may also be used as a captured heater.

Referring again to FIG. 5a, another preferred embodiment may employ element 403 as a thin wire or foil that functions primarily as a heater and only partly as a bonding material. In this case element 403 is in the form of a wire, rod, or foil comprising a refractory electrically conductive material such as carbon or graphite (melt point 3800 K), tungsten (MP 3695K), titanium diboride (MP 3498 K) rhenium (MP 3459 K), titanium carbide (MP 3433 K), tantalum (MP 3290 K), hot-pressed tungsten carbide (MP 3143 K), silicon carbide (decomposes at 3003 K), or molybdenum (MP 2896 K). The electrically conducting refractory material is coated with a bonding material having a boiling point lower than that of the refractory material, such as magnesium (BP1363 K), manganese (BP 2235 K), silver (BP 2485), aluminum (BP 2740 K), boron (BP 2823 K), copper (BP 2840 K), chromium (BP 2945 K), nickel (BP 3005 K), or cobalt (3143 K). If the heater 403 is in the form of a thin foil, it is coated on both sides. Most preferably a tungsten heater is coated with cobalt. The heater is heated rapidly by electrical discharge until a substantial fraction of the coating on the heater is vaporized. The remaining portion of the heater is then rapidly withdrawn, so that only superheated metal vapor remains, as illustrated in FIG. 5b. Portions 401 and 402 are then rapidly brought together, as illustrated in FIG. 5c. In most cases the refractory material will itself have a substantial vapor pressure at the boiling point of the coating, so that at least a small portion of the material of the heater is vaporized with the material of the coating and is retained in the binder.

In another embodiment of the invention, a bonding material is melted at a location distant from the separated portions, is rapidly transferred to a position between the two portions, and the portions are then rapidly brought together. For example, the embodiment shown in FIG. 3a may be configured horizontally, instead of vertically. Electrodes 306 are removed, leaving small holes in sleeve 309. A small body of bonding material, such as a small drop of cobalt, is melted at a location directly above the upper hole in sleeve 309 and is dropped through the hole into the space between mating surfaces 307 and 308. Portions 301 and 302 are rapidly assembled so as to capture at least a fraction of the molten drop of bonding material between the mating surfaces. The drop of bonding material may be conveniently melted by electromagnetic levitation above a small radio frequency induction coil that is positioned above the hole in sleeve 309.

In another embodiment of the invention, the mating surfaces of the two portions may be positioned so that at least one of the mating surfaces can be coated with molten bonding material that is directed at it by a plasma discharge device. The two mating surfaces are rapidly brought together before the molten coating can solidify. In this embodiment one or more of the mating surfaces may also be pre-heated by a form of directed energy, such as by a laser or electron beam, and the molten surface may be maintained by similar means after deposition, while the mating surfaces are being brought together.

The most preferred embodiment of the invention, as described herein, comprises flash heating, by electrical discharge, of a thin wire or foil that is spaced apart from the mating surfaces of the two portions, followed by rapid assembly of the portions in such a manner that at least a fraction of the material of the wire or foil becomes trapped between the mating surfaces. Alternatively, however, a third small body of bonding material may be flash heated by any combination of friction, laser beam, electron beam, radio frequency induction heating, electric discharge between and predominantly normal to the mating surfaces, electrical discharge between and predominantly parallel to the mating surfaces, or by chemical explosive. When any of these alternative heating methods is employed, a third small body of bonding material may not be required, as it may be possible to heat the mating surfaces of the two portions directly. When a third body bonding material is not employed, the mating surfaces are preferably coated with compatible bonding materials and are pre-annealed to enhance adhesion of the coatings to their respective portions.

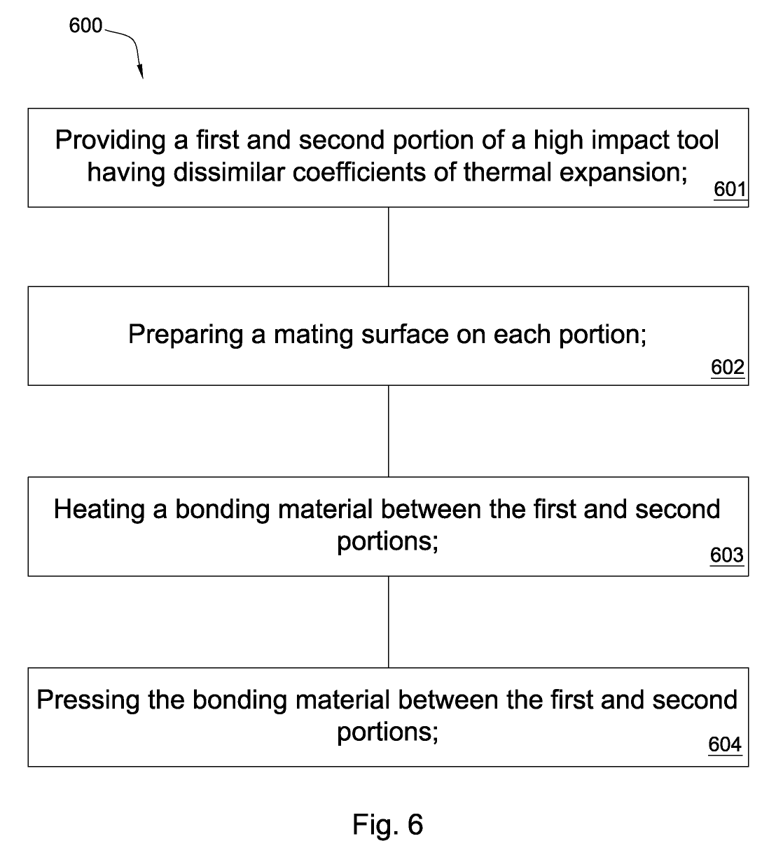

FIG. 6 discloses a method for forming a high impact tool 600 comprising the steps of providing 601 a first and second portion of a high impact tool, preparing 602 a mating surface on each portion, heating 603 a bonding material between the first and second portions, and pressing 604 the bonding material between the first and second portions.

Although the invention has particular application to the bonding of materials having different coefficients of thermal expansion, it also has applicability to bonding of any assembly where it is desirable to minimize heating of any portion of the assembly apart from the immediate bond zone. The process of the invention can also be applied sequentially to bond multiple parts together. A particularly desirable high-impact tool that is made possible by the present invention but not by any other known process comprises four tool layers bonded to a high-impact steel holder. A first thermally stable polycrystalline diamond layer is flash-bonded by the process of the invention to a layer of non-thermally stable diamond. This assembly is then flash-bonded to a stiff layer of low-cobalt cemented tungsten carbide, such as 6 weight-percent cobalt/carbide. The three-layer assembly is then flash-bonded to a tough tool substrate, such as 14 weight-percent cobalt/carbide, and the entire tool is then flash-bonded to a steel rock bit, to a steel percussion bit, to a steel asphalt degradation drum, or to some other type of steel high impact equipment.

Whereas the present invention has been described in particular relation to the drawings attached hereto, it should be understood that other and further modifications apart from those shown or suggested herein, may be made within the scope and spirit of the present invention.

What is claimed is:

1. A method for forming a bonded assembly comprising:
providing a first and second portion of the assembly;
preparing a mating surface on each portion that conforms substantially to the mating surface of the other portion;
rapidly heating a bonding material while substantially heating no more than a thin surface zone adjacent each mating surface; and
rapidly assembling the two portions in such a manner as to confine a fraction of the bonding material between the mating surfaces.

2. The method of claim 1, wherein the bonded assembly comprises a high impact tool.

3. The method of claim 1, wherein the first portion comprises a hard material suitable for impacting, fracturing, crushing, abrading, cutting, indenting, scraping, shearing, compressing, resisting abrasion, resisting erosion, resisting corrosion, or providing a bearing surface, and wherein the second portion comprises a supporting structure for said first portion.

4. The method of claim 3 wherein the hard material comprises diamond or cubic boron nitride.

5. The method of claim 4, wherein the hard material comprises polycrystalline diamond and at least a portion of the polycrystalline diamond is thermally stable.

6. The method of claim 5, wherein at least a portion of any non-diamond material within the polycrystalline diamond is removed or altered, as by acid leaching, electrolytic dissolution; ion implanting, diffusing with another material, or alloying.

7. The method of claim 1, wherein the second portion comprises cobalt-cemented tungsten carbide, any other carbide, a metal, a cermet, or a ceramic.

8. The method of claim 1, wherein the bonding material comprises any combination of:
a thin surface zone within at least one portion that is adjacent to its mating surface;
a thin coating substantially covering at least one of the mating surfaces; and
a separate small body.

9. The method of claim 1, wherein the bonding material comprises tantalum, molybdenum, tungsten, cobalt, nickel, iron, titanium, zirconium, hafnium, vanadium, niobium, chromium, manganese, rhenium, ruthenium, rhodium, iridium, palladium, platinum, copper, silver, gold, zinc, cadmium, boron, aluminum, gallium, indium, silicon, germanium, tin, lead, antimony, bismuth, beryllium, magnesium, a lanthanoid, a carbide, a metal hydride, a metalloid, carbon or graphite, an intercalated graphite compound, a metal-coated polymer, an electrically conducting polymer, a metal-coated ceramic, an electrically conducting ceramic, a cermet, or a semiconductor.

10. The method of claim 9, wherein said bonding material is provided as a thin coating covering at least a portion of either of the mating surfaces.

11. The method of claim 9 wherein the bonding material comprises a thin foil or wire provided as a separate small body.

12. The method of claim 11, wherein the thin foil or wire is heated by an electric current provided by a source comprising a battery, a transformer, a low-internal resistance AC or DC power supply, a capacitor, a homopolar generator, or a Marx generator.

13. The method of claim 1, wherein the mating surfaces form a solid solution or eutectic with each other or where either material of either mating surface, in its liquid form, forms a contact angle with the other mating surface that is less than 90 degrees.

14. The method of claim 1, wherein the mating surface of the first portion comprises diamond and the diamond is first coated with any combination of the group comprising titanium, zirconium, hafnium, vanadium, niobium, tantalum, chromium, molybdenum, tungsten, manganese, rhenium, ruthenium, rhodium, iridium, palladium, platinum, boron, silicon, and a lanthanoid; and the first coating is subsequently coated with any combination of the group comprising cobalt, nickel, iron, copper, silver, gold, zinc, cadmium, beryllium, magnesium, aluminum, gallium, indium, germanium, tin, lead, antimony, or bismuth.

15. The method of claim 1, wherein the heat capacity of the fraction of the bonding material that is trapped between the two portions, at the bonding temperature, is less than one-half of the heat capacity of either portion at room temperature.

16. The method of claim 1, wherein the bonding material is heated to at least its melting point.

17. The method of claim 1, wherein the bonding material is heated to at least its boiling point.

18. The method of claim 1, wherein the bonding material is heated by transient pulse of energy provided by any combination of friction, laser beam, electron beam, radio frequency induction heating, electric discharge between and predominantly normal to the mating surfaces, electrical discharge between and predominantly parallel to the mating surfaces, or by chemical explosive.

19. The method of claim 1, wherein the bonding is conducted in vacuum, a reducing atmosphere, or an inert atmosphere.

20. The method of claim 1, wherein the first and second portions and the bonding material are contained within a close-fitting refractory sleeve during the steps of heating and assembling.

21. A high impact tool formed by a process comprising the steps of;
providing a first and second portion of the tool;
preparing a mating surface on one portion that conforms substantially to the mating surface of the other portion;
rapidly heating a bonding material while substantially heating no more than a thin surface zone adjacent each mating surface; and
rapidly assembling the two portions in such a manner as to confine a fraction of the bonding material between the mating surfaces.

22. The tool of claim 21, wherein the first portion comprises polycrystalline diamond, at least a portion of which may be thermally stable, and the second portion comprises a support material comprising cemented-cobalt tungsten carbide, a carbide, a metal, a cermet, or a ceramic.

23. The tool of claim 21, wherein the polycrystalline diamond comprises a working surface that is substantially pointed, substantially dome shaped, substantially cylindrical, or substantially flat.

24. A method of bonding a high impact tool to a tool holder, comprising the steps of:
preparing a mating surface on the high-impact tool that conforms substantially to a mating surface on the tool holder;
rapidly heating a bonding material while substantially heating no more than a thin surface zone adjacent each mating surface; and
rapidly assembling the high impact tool and the tool holder in such a manner as to confine a fraction of the bonding material between the mating surfaces.

25. The method of claim 24 wherein the high impact tool comprises polycrystalline diamond and the tool holder comprises steel, such as a steel-body rock bit, a steel asphalt disintigrator drum, a steel-body concrete pavement disintigrator, or other high-impact steel-body tool or steel-body machine.
